(19) United States
(12) Patent Application Publication
(10) Pub. No.: US 2025/0159509 A1
(43) Pub. Date: May 15, 2025

(54) SYSTEMS AND METHODS FOR REAL-TIME ERROR CORRECTION OF WIRELESS DATA TRANSMISSIONS

(71) Applicant: Mixhalo Corp., San Francisco, CA (US)

(72) Inventor: Vikram Singh, San Francisco, CA (US)

(21) Appl. No.: 18/949,301

(22) Filed: Nov. 15, 2024

Related U.S. Application Data
(60) Provisional application No. 63/599,309, filed on Nov. 15, 2023.

(51) Int. Cl. H04W 24/04; G06F 3/16; H04L 49/9057; H04L 65/61

(52) U.S. Cl. CPC H04W 24/04; G06F 3/165; H04L 49/9057; H04L 65/61

(57) ABSTRACT

A method for transmission of live audio data to a mobile computing device at a live event includes receiving a live audio signal corresponding to the live event. The method also includes receiving one or more performance characteristics corresponding to the mobile computing device at the live event. The method also includes determining a data packet payload mapping based on the one or more performance characteristics and a machine learning algorithm. The method also includes processing the live audio signal based on the determined data packet payload mapping, thereby creating a data representation of the live audio signal. The method also includes transmitting the data representation of the live audio signal to the mobile computing device at the live event via a wireless network.

### RELATED APPLICATIONS

This application claims priority to U.S. Provisional No. 63/599,309, filed Nov. 15, 2023, the entire disclosure of which is incorporated herein by reference.

### TECHNICAL FIELD

This invention relates generally to the field of real-time delivery of data, such as audio, over wireless networks. More specifically, the invention relates to systems and methods for error correcting real-time transmission of data over wireless networks based on machine learning.

### BACKGROUND

Attendees of live events (e.g., concerts, sporting events) often bring and use their mobile computing device to stream data (e.g., audio or video) using at least one of the available wireless networks at the venue (e.g., WiFi™ or cellular). However, due to the large number of attendees at live events, data streaming from the available wireless networks at the venue may suffer from an undesirable or unbearable amount of latency and/or instability.

Several error correction techniques exist to alleviate the instability experienced on data streams—each optimized for a range of conditions. Therefore, there is a need for systems and methods that allow server computing devices to automatically switch from one error correction technique to another better suited for current conditions without interrupting the data stream.

### SUMMARY

The present invention includes systems and methods for transmission of live audio data to a mobile computing device at a live event based on a machine learning algorithm. For example, the present invention includes systems and methods for receiving a live audio signal corresponding to the live event and one or more performance characteristics corresponding to the mobile computing device at the live event. The present invention also includes systems and methods for determining a data packet payload mapping based on the one or more performance characteristics and a machine learning algorithm and processing the live audio signal based on the determined data packet payload mapping.

In one aspect, the invention includes a computerized method for transmission of live audio data to a mobile computing device at a live event. The computerized method includes receiving a live audio signal corresponding to the live event by an audio server computing device. The computerized method also includes receiving one or more performance characteristics corresponding to the mobile computing device at the live event by the audio server computing device. The computerized method also includes determining a data packet payload mapping based on the one or more performance characteristics and a machine learning algorithm by the audio server computing device.

The computerized method also includes processing the live audio signal based on the determined data packet payload mapping by the audio server computing device, thereby creating a data representation of the live audio signal. The data representation of the live audio signal including audio data packets. The computerized method also includes transmitting the audio data packets to the mobile computing device at the live event by the audio server computing device via a wireless network.

In some embodiments, the computerized method further includes receiving the live audio signal corresponding to the live event via an audio interface communicatively coupled to the audio server computing device.

In some embodiments, the one or more performance characteristics include at least one of an operating system of the mobile computing device, one or more wireless connection capabilities of the mobile computing device, a connection history of the mobile computing device, or an amount of battery life remaining of the mobile computing device.

In some embodiments, the determined data packet payload mapping corresponds to a packet-frame mapping scheme. For example, in some embodiments, the determined data packet payload mapping corresponds to a multi-stride packet-frame mapping scheme. In other embodiments, the determined data packet payload mapping corresponds to a scrambled packet-frame mapping scheme.

In another aspect, the invention includes a system for transmission of live audio data to a mobile computing device at a live event. The system includes an audio server computing device communicatively coupled to a mobile computing device over a wireless network. The audio server computing device is configured to receive a live audio signal corresponding to the live event. The audio server computing device is also configured to receive one or more performance characteristics corresponding to the mobile computing device at the live event. The audio server computing device is also configured to determine a data packet payload mapping based on the one or more performance characteristics and a machine learning algorithm.

The audio server computing device is also configured to process the live audio signal based on the determined data packet payload mapping, thereby creating a data representation of the live audio signal, the data representation of the live audio signal including audio data packets. The audio server computing device is also configured to transmit the audio data packets to the mobile computing device at the live event via the wireless network.

In some embodiments, the audio server computing device is further configured to receive the live audio signal corresponding to the live event via an audio interface communicatively coupled to the audio server computing device.

In some embodiments, the one or more performance characteristics include at least one of an operating system of the mobile computing device, one or more wireless connection capabilities of the mobile computing device, a connection history of the mobile computing device, or an amount of battery life remaining of the mobile computing device.

In some embodiments, the determined data packet payload mapping corresponds to a packet-frame mapping scheme. For example, in some embodiments, the determined data packet payload mapping corresponds to a multi-stride packet-frame mapping scheme. In other embodiments, the determined data packet payload mapping corresponds to a scrambled packet-frame mapping scheme.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for real-time delivery of live event data over wireless networks, according to an illustrative embodiment of the invention.

FIG. 2 is a schematic diagram of a system architecture for duplication and transmission of live audio data to one or more mobile computing devices at a live event, according to an illustrative embodiment of the invention.

FIG. 3 is a schematic flow diagram illustrating method steps for transmission of live audio data to a mobile computing device at a live event based on a machine learning algorithm, according to an illustrative embodiment of the invention.

### DETAILED DESCRIPTION

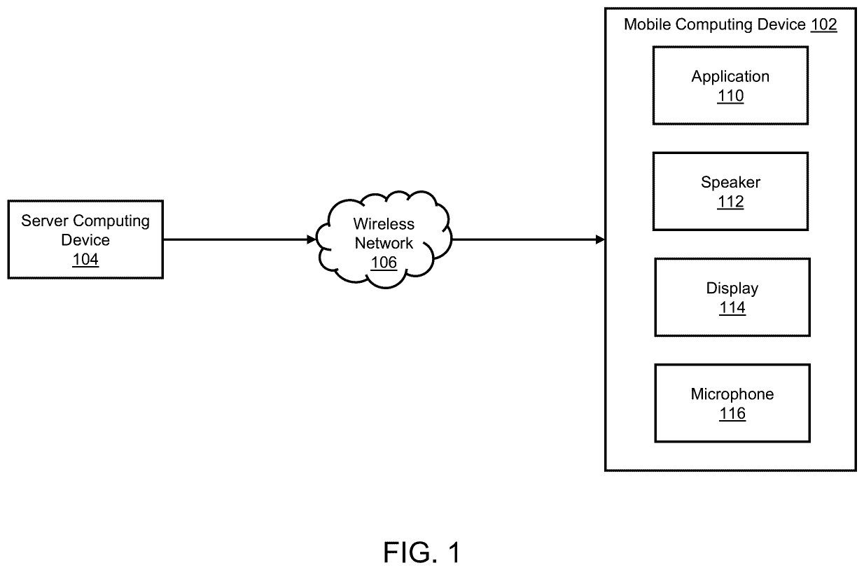

FIG. 1 is a schematic diagram of a system architecture 100 for real-time delivery of live event data over wireless networks, according to an illustrative embodiment of the invention. System 100 includes one or more mobile computing devices 102 communicatively coupled to a server computing device 104 (or audio server computing device) over one or more wireless networks 106. Mobile computing device 102 includes an application 110, one or more speakers 112, one or more displays 114, and one of more microphones 116. In some embodiments, the server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices.

Mobile computing device 102 is configured to receive a data representation of a live audio signal corresponding to the live event via wireless network 106. For example, in some embodiments, mobile computing device 102 is configured to receive the data representation of the live audio signal corresponding to the live event from server computing device 104 via wireless network 106, where server computing device 104 is coupled to an audio source at the live event (e.g., a soundboard that is capturing live audio). Mobile computing device 102 is also configured to process the data representation of the live audio signal into a live audio stream.

Mobile computing device 102 is also configured to initiate playback of the live audio stream via a first headphone (not shown) communicatively coupled to the mobile computing device 102 at the live event. For example, the user of mobile computing device 102 can connect a headphone to the device via a wired connection (e.g., by plugging the headphone into a jack on the mobile computing device) or via a wireless connection (e.g., pairing the headphone to the mobile computing device via a short-range communication protocol such as Bluetooth™). Mobile computing device 102 can then initiate playback of the live audio stream via the headphone.

Additional detail regarding illustrative technical features of the methods and systems described herein are found in U.S. Pat. No. 11,461,070, titled “Systems and Methods for Providing Real-Time Audio and Data” and issued Oct. 24, 2022, and U.S. Pat. No. 11,625,213, titled “Systems and Methods for Providing Real-Time Audio and Data,” and issued Apr. 11, 2023, the entirety of each of which is incorporated herein by reference.

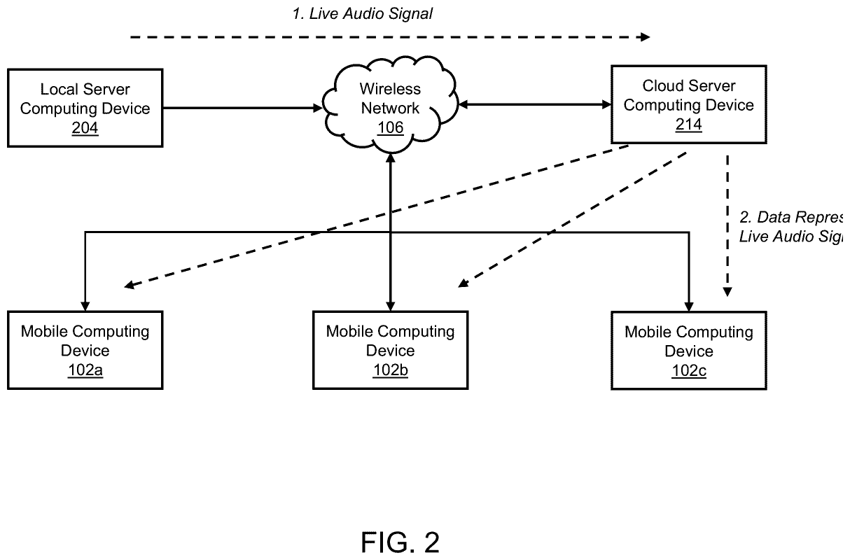

FIG. 2 is a schematic diagram of a system architecture 200 for duplication and transmission of live audio data to one or more mobile computing devices at a live event, according to an illustrative embodiment of the invention. Similar to system 100, system 200 includes a local server computing device 204 (or local audio server computing device) communicatively coupled to a cloud server computing device 214 (or cloud-based audio server computing device) via the wireless network 106. System 200 also includes at least two or more mobile computing devices (in this example, three mobile computing devices 102a-102c) communicatively coupled to the cloud server computing device 214 via the wireless network 106.

Local server computing device 204 includes specialized hardware and/or software modules that execute on one or more processors and interact with one or more memory modules of local server computing device 204, to receive data from other components of system 200, transmit data to other components of system 200, and perform functions for capturing a live audio signal and transmitting audio packets corresponding to the live audio signal to cloud server computing device 214 as described herein. In some embodiments, local server computing device 204 comprises software modules that carry out the audio signal processing described herein, where the modules are specialized sets of computer software instructions programmed onto one or more dedicated processors in local server computing device 204 and can include specifically designated memory locations and/or registers for executing the specialized computer software instructions.

Cloud server computing device 214 is a combination of hardware, including one or more computing devices comprised of special-purpose processors and one or more physical memory modules, and specialized software in a cloud computing environment, to receive and process audio signal packets from local server computing device 204. Exemplary cloud computing platforms that can be used for cloud server computing device 214 include, but are not limited to, Amazon® Web Services (AWS); IBM® Cloud™; Google® Cloud™; and Microsoft® Azure™. It should be appreciated that other types of resource distribution, allocation, and configuration in a cloud-based computing environment can be used within the scope of the technology described herein

System 200 can be configured for duplication and transmission of live audio data to one or more mobile computing devices 102 at a live event. For example, the cloud audio server computing device 214 can be configured to receive a live audio signal corresponding to the live event. In some embodiments, the cloud audio server computing device 214 is configured to receive the live audio signal corresponding to the live event from the local audio server computing device 204 via the wireless network 106. The cloud audio server computing device 214 can also be configured to process the live audio signal, thereby creating a data representation of the live audio signal. The data representation of the live audio signal including audio data packets. The cloud audio server computing device 214 can also be configured to duplicate each of the audio data packets into duplicated audio data packets. The cloud audio server computing device 214 is also configured to concurrently transmit the duplicated audio data packets to the one or more mobile computing devices 102 at the live event via the wireless network 106.

In some embodiments, the cloud audio server computing device 214 is also configured to transmit a first duplicated audio data packet to a first mobile computing device 102 at the live event via the wireless network 106 at a first time. For example, in some embodiments, the first mobile computing device 102 is configured to receive the first duplicated audio data packet.

In some embodiments, the cloud audio server computing device 214 is also configured to transmit a second duplicated audio data packet to a second mobile computing device 102 at the live event via the wireless network 106 at the first time. For example, in some embodiments, the second mobile computing device 102 is configured to receive the second duplicated audio data packet.

In some embodiments, the cloud audio server computing device 214 is also configured to transmit a third duplicated audio data packet to a third mobile computing device 102 at the live event via the wireless network 106 at the first time. For example, in some embodiments, the third mobile computing device 102 is configured to receive the third duplicated audio data packet.

In some embodiments, system 200 further includes an audio interface communicatively coupled to the local audio server computing device 204. For example, in some embodiments, the local audio server computing device 204 is also configured to receive the live audio signal corresponding to the live event via the audio interface communicatively coupled to the local audio server computing device 204. In some embodiments, the system further includes at least one wireless network access point communicatively coupled to the local audio server computing device 204.

It should be appreciated that each of the mobile computing devices 102a, 102b, 102c described above can comprise different technical characteristics or features. For example, mobile computing device 102a may comprise an iPhone® running iOS™, mobile computing device 102b may comprise an Android®-based smartphone, and mobile computing device 102c may comprise a Microsoft® Surface™ tablet. In another example, mobile computing device 102a may connect to wireless network 106 via a WiFi™ connection using embedded antenna circuitry while mobile computing devices 102b and 102c may connect to wireless network 106 via a cellular-based connection. The methods and systems described herein advantageously analyze the particular technical characteristics of the mobile computing device, the features of the wireless connection(s) available to the mobile computing device, and changes to those characteristics and features over time, in order to adjust the data packet payload mapping scheme used by local server computing device 204 and/or cloud server computing device 214 to deliver a data representation of the live audio signal (e.g., an audio data stream) to the mobile computing device. As a result, the mobile computing device receives an uninterrupted audio data stream that is automatically adjusted for connection instability and/or device performance constraints in real time without requiring active connection switching by the end user.

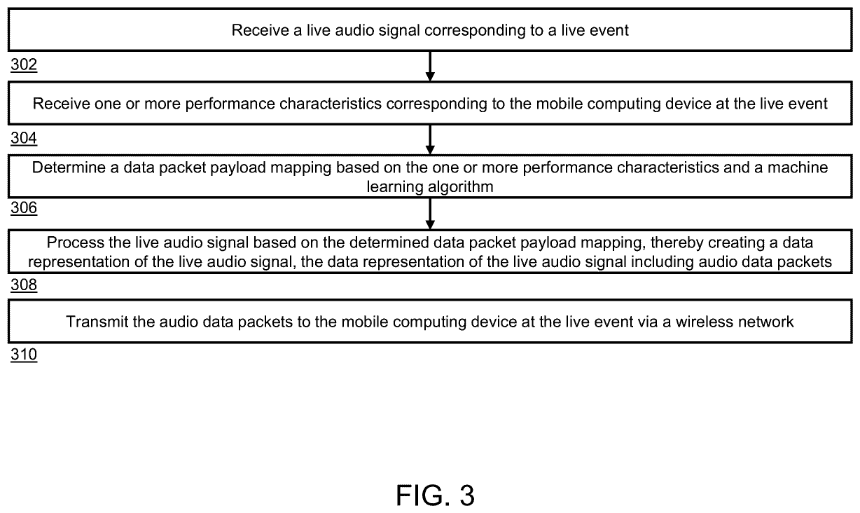

FIG. 3 is a schematic flow diagram illustrating a computerized process 300 for transmission of live audio data to a mobile computing device 102 at a live event using system 200, according to an illustrative embodiment of the invention. Process 300 begins by receiving a live audio signal corresponding to the live event by an audio server computing device (i.e., local server computing device 204 and/or cloud server computing device 214) at step 302. For example, in some embodiments, receiving the live audio signal corresponding to the live event includes receiving the live audio signal corresponding to the live event via an audio interface communicatively coupled to the audio server computing device.

Process 300 continues by receiving one or more performance characteristics corresponding to a mobile computing device 102 at the live event by the cloud server computing device 214 at step 304. In some embodiments, the one or more performance characteristics include at least one of: an operating system of the mobile computing device 102 (e.g., operating system type, operating system version number); one or more wireless connection capabilities of the mobile computing device 102 (e.g., WiFi™, cellular (LTE, 5G, 4G, or others)); a connection history of the mobile computing device 102, and an amount of battery life remaining of the mobile computing device 102. In some embodiments, upon establishing an initial connection with cloud server computing device 214 to receive the data representation of the live audio signal, mobile computing devices 102a-102c can transmit a baseline set of performance characteristics to cloud server computing device 214. In some embodiments, mobile computing devices 102a-102c can periodically transmit changes to the performance characteristics to cloud server computing device 214. For example, as the battery charge of mobile computing device 102 depletes over time, mobile computing device 102 sends an update of the amount of battery life remaining to local server computing device 204 and/or cloud server computing device 214, which stores the updated battery life amount in a data record associated with mobile computing device 102.

Process 300 continues by determining a data packet payload mapping based on the one or more performance characteristics and a machine learning algorithm by the local server computing device 204 and/or cloud server computing device 214at step 306. As can be appreciated, one or more of the performance characteristics associated with each individual mobile computing device 102a-102c can impact the type of data packet payload mapping that should be used by cloud server computing device 214 to provide an optimal quality and/or uninterrupted data stream to the respective mobile computing device 102a-102c.

In some embodiments, the determined data packet payload mapping corresponds to a packet-frame mapping scheme. For example, in some embodiments, the determined data packet payload mapping corresponds to a multi-stride packet-frame mapping scheme. In other embodiments, the determined data packet payload mapping corresponds to a scrambled packet-frame mapping scheme. Additional detail regarding data packet payload mapping is described in U.S. patent application Ser. No. 18/132,699, titled “Packet Payload Mapping for Robust Transmission of Data,” filed on Apr. 10, 2023, U.S. patent application Ser. No. 18/210,800, titled “Multi-Stride Packet Payload Mapping for Robust Transmission of Data,” filed on Jun. 16, 2023, and U.S. patent application Ser. No. 17/964,109, titled “Scrambled Packet Payload Mapping for Robust Transmission of Data,” filed on Oct. 12, 2022, the entirety of each of which is incorporated herein by reference.

As mentioned above, the systems and methods described herein can be implemented using supervised learning and/or machine learning algorithms. Supervised learning is the machine learning task of learning a function that maps an input to an output based on example of input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples. Generally, machine learning is defined as enabling computers to learn from input data without being explicitly programmed to do so by using algorithms and models to analyze and draw inferences or predictions from patterns in the input data. Typically, the learning process is performed iteratively—e.g., a trained machine learning model analyzes new input data, and the output is compared against expected output to refine the performance of the model. This iterative aspect allows computers to identify hidden insights and repeated patterns and use these findings to adapt when exposed to new data. As can be appreciated, machine learning algorithms and processing can be applied by cloud server computing device 214 when analyzing the performance characteristics received from one or more of the mobile computing devices 102a-102c to identify a data packet payload mapping scheme that should be used to deliver audio packets to the mobile computing device. In some embodiments, the machine learning model used to analyze the performance characteristics and identify a suitable data packet payload mapping scheme is a classification model—where the model receives as input the performance characteristics (in raw form and/or converted into a multidimensional feature embedding or vector representation) and analyzes the input data to generate a classification or label that corresponds to a type of data packet payload mapping scheme.

In some embodiments, cloud server computing device 214 executes a trained machine learning (ML) classification model to determine the data packet payload mapping that will be used to deliver audio packets to each mobile computing device 102a-102c. The ML classification model is trained on curated and/or historical performance characteristic data from a plurality of mobile computing devices that has been labeled with corresponding data packet payload mapping schemes selected for those performance characteristics. The ML classification model is trained to identify a predicted data packet payload mapping scheme preferable for transmitting data packets to a mobile computing device having the input performance characteristics, based upon what the model learns by ingesting and evaluating the training data. For example, an exemplary output from the trained ML model can comprise a text label corresponding to the estimated or predicted data packet payload mapping scheme to use in view of the input feature values. In some embodiments, the ML model comprises a Long Short Term Memory (LSTM) neural network that generates a binary output label (e.g., HIGH QUALITY, LOW QUALITY) and/or a numeric output value for each vector representation. Further detail on using network quality metrics to evaluate whether a connection is optimal in the context of live video (where such techniques are equally applicable to live audio) is described in S. C. Madanapalli et al., “Modeling Live Video Streaming: Real-Time Classification, QoE Inference, and Field Evaluation,” arXiv:2112.02637v1 [cs.NI] Dec. 5, 2021, available at arxiv.org/pdf/2112.02637, which is incorporated by reference.

Once the ML model executing on cloud server computing device 214 has generated a predicted data packet payload mapping scheme to be used for transmitting a data representation of the live audio signal to a particular mobile computing device 102a-102c, process 300 continues with cloud server computing device 214 processing the live audio signal based on the determined data packet payload mapping to create a data representation of the live audio signal at step 308. The data representation of the live audio signal includes audio data packets that have been generated according to the specific data packet payload mapping scheme identified by the ML model. Process 300 finishes by transmitting the audio data packets to the mobile computing device 102 at the live event by the audio server computing device 104 via a wireless network 106 at step 310.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account-which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

While the invention has been particularly shown and described with reference to specific preferred embodiments, it should be understood by those skilled in the art that various changes in form and detail may be made therein without departing from the spirit and scope of the invention as defined by the following claims.

What is claimed is:

1. A computerized method for transmission of live audio data to a mobile computing device at a live event, the method comprising:
receiving, by an audio server computing device, a live audio signal corresponding to the live event;
receiving, by the audio server computing device, one or more performance characteristics corresponding to the mobile computing device at the live event;
determining, by the audio server computing device, a data packet payload mapping based on the one or more performance characteristics and a machine learning algorithm;
processing, by the audio server computing device, the live audio signal based on the determined data packet payload mapping, thereby creating a data representation of the live audio signal, the data representation of the live audio signal comprising a plurality of audio data packets; and
transmitting, by the audio server computing device, the plurality of audio data packets to the mobile computing device at the live event via a wireless network.

2. The computerized method of claim 1, wherein receiving the live audio signal corresponding to the live event comprises:
receiving, by the audio server computing device, the live audio signal corresponding to the live event via an audio interface communicatively coupled to the audio server computing device.

3. The computerized method of claim 1, wherein the one or more performance characteristics comprise at least one of:
an operating system of the mobile computing device;
one or more wireless connection capabilities of the mobile computing device;
a connection history of the mobile computing device; or
an amount of battery life remaining of the mobile computing device.

4. The computerized method of claim 1, wherein the determined data packet payload mapping corresponds to a packet-frame mapping scheme.

5. The computerized method of claim 4, wherein the determined data packet payload mapping corresponds to a multi-stride packet-frame mapping scheme.

6. The computerized method of claim 4, wherein the determined data packet payload mapping corresponds to a scrambled packet-frame mapping scheme.

7. A system for transmission of live audio data to a mobile computing device at a live event, the system comprising:
an audio server computing device communicatively coupled to a mobile computing device over a wireless network, the audio server computing device configured to:
receive a live audio signal corresponding to the live event;
receive one or more performance characteristics corresponding to the mobile computing device at the live event;
determine a data packet payload mapping based on the one or more performance characteristics and a machine learning algorithm;
process the live audio signal based on the determined data packet payload mapping, thereby creating a data representation of the live audio signal, the data representation of the live audio signal comprising a plurality of audio data packets; and
transmit the plurality of audio data packets to the mobile computing device at the live event via the wireless network.

8. The system of claim 7, wherein the audio server computing device is further configured to:
receive the live audio signal corresponding to the live event via an audio interface communicatively coupled to the audio server computing device.

9. The system of claim 7, wherein the one or more performance characteristics comprise at least one of:
an operating system of the mobile computing device;
one or more wireless connection capabilities of the mobile computing device;
a connection history of the mobile computing device; or
an amount of battery life remaining of the mobile computing device.

10. The system of claim 7, wherein the determined data packet payload mapping corresponds to a packet-frame mapping scheme.

11. The system of claim 10, wherein the determined data packet payload mapping corresponds to a multi-stride packet-frame mapping scheme.

12. The system of claim 10, wherein the determined data packet payload mapping corresponds to a scrambled packet-frame mapping scheme.
